(19) United States
(12) Patent Application Publication
(10) Pub. No.: US 2015/0094903 A1
(43) Pub. Date: Apr. 2, 2015

(54) VEHICLE DIAGNOSTIC AND PROGNOSTIC SYSTEMS AND METHODS

(71) Applicant: Ford Global Technologies, LLC, Dearborn, MI (US)

(72) Inventor: Christopher W. Bell, Livonia, MI (US)

(73) Assignee: Ford Global Technologies, LLC, Dearborn, MI (US)

(21) Appl. No.: 14/041,030

(22) Filed: Sep. 30, 2013

(51) Int. Cl. G07C 5/00

(52) U.S. Cl. CPC G07C 5/008
USPC 701/31.4; 701/1

(57) ABSTRACT

A diagnostic device having a computer processor in communication with a wireless transceiver, the wireless transceiver capable of communication with a remote computer located remotely from the processor. The computer processor may be configured to enable the diagnostic device to select one or more variables from a database in communication with the remote computer. The computer processor may generate a diagnostic instruction for a vehicle based on the one or more variables, the diagnostic instruction including data from memory of one or more modules that is not available on a vehicle network. The diagnostic device may transmit the custom diagnostic instruction to a vehicle in communication with the remote computer. The diagnostic device may receive at least a portion of the data in response to the diagnostic instruction from the vehicle.

### TECHNICAL FIELD

The present disclosure relates to methods and systems for diagnosing customer complaints in a vehicle and recording diagnostic data and other information relating to the operating conditions of the vehicle and transmitting a portion of the recorded data to a device.

### BACKGROUND

U.S. Pat. No. 7,317,975 generally discloses a system providing tracking and wireless communications for remote diagnostics of a vehicle. The system transmits data communicated over a vehicle system's CAN bus to a remote location. The system is adapted to use data received from a vehicle in order to compare the performance of the vehicle and/or of the operator of the vehicle with the performance of other vehicles and/or operators of other vehicles. The system incorporates advanced power management functionality for conserving power, particularly when the system is disconnected from a main power supply, and which facilitates the identification of vehicles that have not reported back to the system or that have not moved within a specified time period.

U.S. Pat. No. 6,956,501 generally discloses an improved monitoring system for use with motor vehicles having a plurality of sensors for measuring the performance of the vehicle and a memory for storing information specifying data derived from the sensors. The disclosure includes a wireless communication link for transmitting the information to a terminal that is proximate to the vehicle. The terminal communicates information processed by the terminal to the operator of the vehicle. The disclosure can be implemented by installing a connector into the standard scanner port on the vehicle. The connector includes a wireless link that emulates a connection to a conventional vehicle scanner by generating control signals on the appropriate conductors on the scanner port.

U.S. Patent Application 2013/0204484 generally discloses a microprocessor executable diagnostic module operable to receive, from a vehicle component, a signal regarding a warning and/or error and select a destination for the signal from a plurality of destinations. The plurality of destinations comprising one or more of a vehicle input/output system to present the warning and/or error to a vehicle occupant, an emergency service provider, an emergency responder, a manufacturer of the vehicle, a service facility located in proximity to a current vehicle location, and a remotely located diagnostic service to diagnose a cause of the warning and/or error signal.

### SUMMARY

In the first illustrative embodiment, a diagnostic device having a computer processor in communication with a wireless transceiver, the wireless transceiver capable of communication with a remote computer located remotely from the processor. The computer processor may be configured to enable the diagnostic device to select one or more variables from the remote computer in communication with a database. The computer processor may generate a diagnostic instruction for a vehicle based on the one or more variables, the diagnostic instruction including data from memory of one or more modules that is not available on a vehicle network. The diagnostic device may transmit the custom diagnostic instruction to a vehicle in communication with the remote computer. The diagnostic device may receive at least a portion of the data in response to the diagnostic instruction from the vehicle.

In the second illustrative embodiment, a non-transitory computer readable storage medium, storing instructions that, when executed by a processor, configure the processor to select one or more variables from a database in communication with the processor. The instructions may further configure the processor to generate a diagnostic instruction for a vehicle based on the one or more variables, wherein the diagnostic instruction includes a request for data from memory of one or more modules that is not available on a vehicle network. The instructions configure the processor to transmit the diagnostic instruction to the vehicle in communication with the processor and receive from the vehicle at least a portion of the data in response to the diagnostic instruction.

In the third illustrative embodiment, a method may include selecting a variable from a database, such that the variable represents a memory location. The method may generate an instruction for a vehicle based on the variable, wherein the instruction includes a trigger and a request for data from memory of one or more modules that is not available on a vehicle network. The method may transmit the instruction to the vehicle and receive from the vehicle at least a portion of the data in response to the instruction.

### BRIEF DESCRIPTION OF THE DRAWINGS

FIG. 1 illustrates an example block topology for a vehicle based computing system for a vehicle;

FIG. 2 illustrates an example block topology for a vehicle based computing system communicating with a remote server;

FIG. 3 is a flow diagram illustrating an example processes for implementing embodiments of the present disclosure;

FIG. 4 is a flow chart illustrative of a technician device for communicating with a vehicle computing system;

FIG. 5 is a flow chart illustrative of a remote server for communicating an engineering device to a vehicle computing system;

FIG. 6 is an example block topology for a computer device having one or more customized applications used for prognostics of a vehicle computing system;

FIG. 7A is an example graphical user interface (GUI) for receiving data from one or more diagnostic routines executed in a vehicle;

FIG. 7B is an example graphical user interface (GUI) for displaying data from one or more diagnostic routines executed in a vehicle;

FIG. 8 is an example GUI of selecting one or more data identifiers from a device to be used in a diagnostic instruction and transmitted to a vehicle computing system;

FIG. 9 is an example GUI of selecting diagnostic capture triggers to be used in a diagnostic instruction and transmitted to a vehicle computing system; and

FIG. 10 is a flow chart of a diagnostic device for generating and transmitting an instruction set to capture one or more variables on a vehicle computing system.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

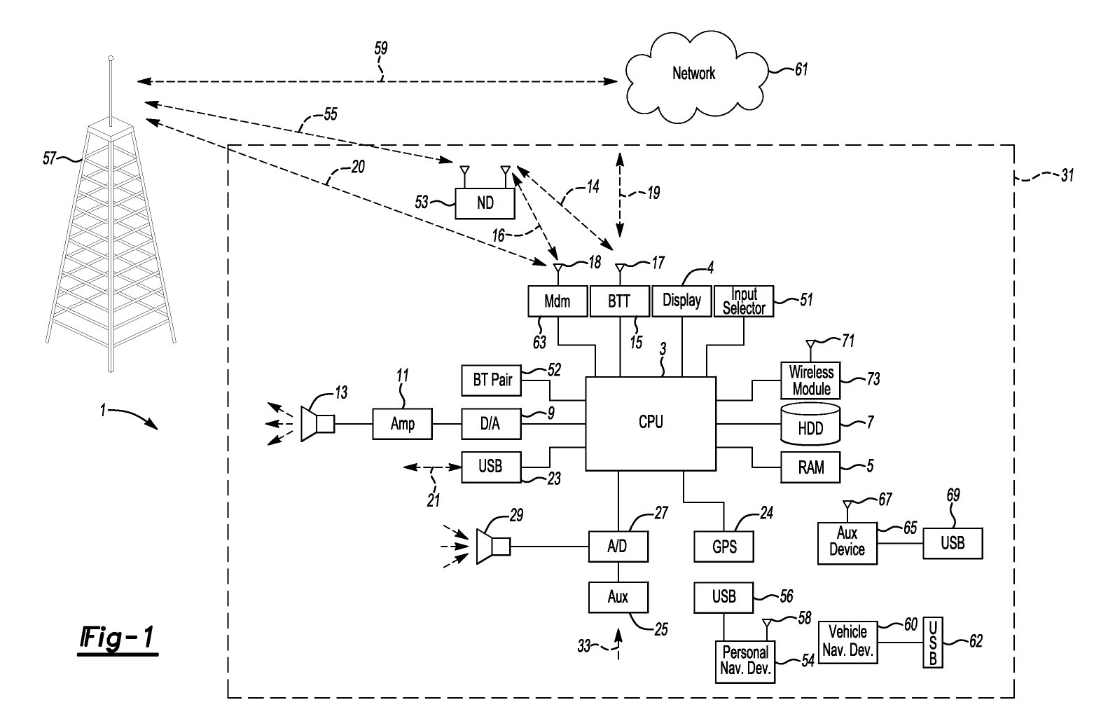

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

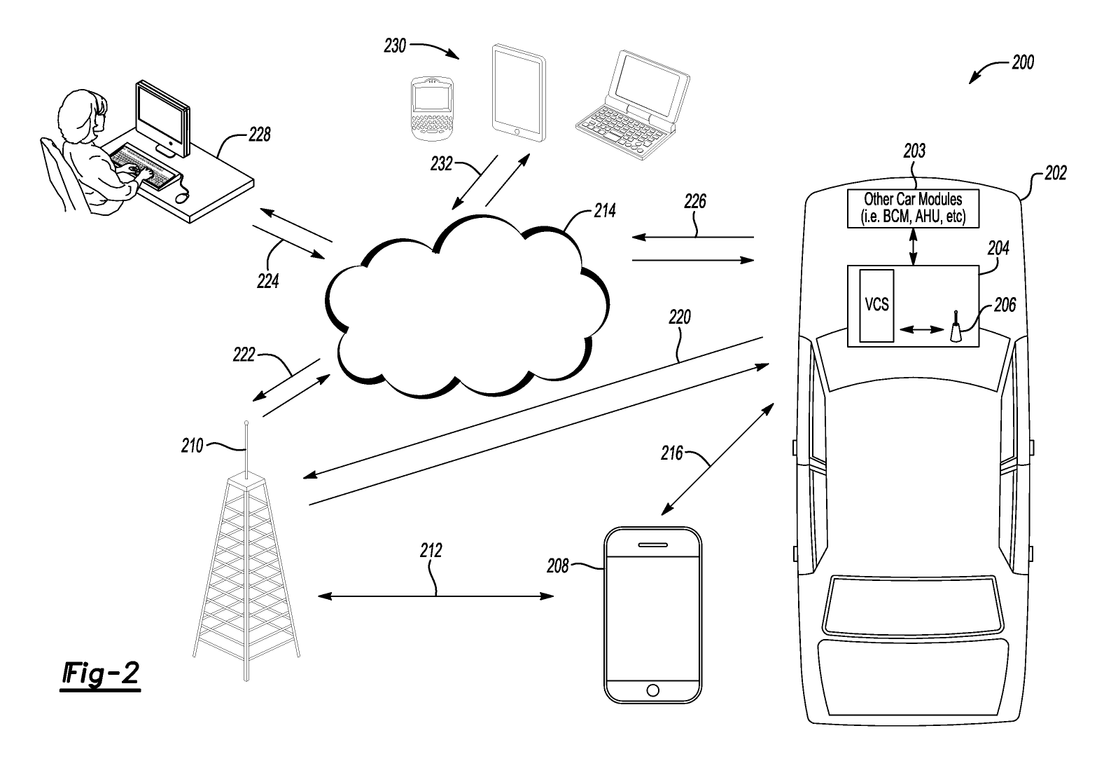

FIG. 2 illustrates an example block topology for a vehicle based computing system communicating with a remote server. In one embodiment of the present disclosure, a nomadic device 208 communicating 216 with the VCS 204 using BLUETOOTH technology may establish wireless communication 212 with a terrestrial tower 210. The terrestrial tower 210 in turn may establish communication 222 through a telephone switching network with a remote server 214. The remote server 214 may be in communication with one or more terminals 228 located remotely from each other. The one or more terminals 228 may be in several locations including, but not limited to, a dealership service garage, engineering facility, and/or at a technical service representative office.

The VCS 204 may connect with a wireless device, or a remote computing system connected through the wireless device, for establishing communication with the remote server 214. The wireless device may include, but is not limited to, an embedded cellular modem, embedded WiFi device, Bluetooth transmitter, Near Field Communication connected to phone, brought-in cellular device like a USB modem, MiFi, smartphone 208 that may be connected to the vehicle through SYNC or other Bluetooth pairing device, or a PC network that may be connected to the vehicle through SYNC or other Bluetooth pairing device. The VCS 204 may wirelessly communicate a data transmission with the remote server 214 with the use of the wireless device. Once the vehicle system has enabled communication with the remote server 214, information can proceed to be transmitted and received by the VCS from the one or more terminals 228 and/or diagnostic devices 230 in communication 224 232 with the server.

In another example, an embedded cellular phone within the VCS 204 may establish direct communication 220 with a terrestrial tower 210 using a wireless transceiver 206. The VCS 204 with an embedded telephone may establish communication with the remote server 214 using the terrestrial tower connection 222 allowing data uploaded and downloaded to one or more modules 203 from a device 230 connected 232 to the remote server.

The VCS 204 may also communicate with a network having associated storage hosting a plurality of web pages for internet access by a plurality of browsers, including but not limited to assembly plants, dealerships, service garages, original equipment manufacturer (OEM), etc. Some browsers, such as cellular telephone owners may upload data over the Internet to storage, and other browsers, such as an OEM network may download data to the remote server. The data may be uploaded and downloaded using several types of transmission mediums including, but not limited to, narrowband, broadband, and/or voice over internet protocol.

The remote server 214 may receive a transmission request of a diagnostic instruction including a portion of data from the one or more modules 203 in a vehicle 202 including, but not limited to, a direct memory read of variables not available on the vehicle network. A method for transmitting this information from the VCS to the server may include, but is not limited to, in-band modem or data-over-voice. Once the information is received by the remote server 214, one or more algorithms may be used to interrupt the data so that the vehicle identification number (VIN) is used with the data such that the remote server may organize and communicate the information received by the vehicle to the one or more terminals 228 based on the VIN.

The requested and received vehicle data may also be controlled on a wireless diagnostic tool 230 in communication 232 with the remote server 214. Once the set of data has been transmitted from the vehicle 202 to the remote server 214, the data may be associated with the respective VIN. The received data from the one or more control modules 203 in a vehicle 202 may be analyzed by the one or more terminals 228 and/or the wireless diagnostic tool. The remote server 214 may send one or more instructions to the VCS 204 indicating a request for additional data based on received input from the one or more terminals 228 and/or the wireless diagnostic tool 230.

The vehicle computing system 204 may be configured to receive a custom application that may allow real-time access to the vehicle communication bus. The custom application may request data including, but not limited to, direct memory reads of a variable located on a specific module, an algorithm that may trigger the transmittal of one or more data points, an alert of when a certain maneuver has taken place in the vehicle system, and/or a combination thereof. A product engineer, service technician, and/or field service representative using a terminal 228 and/or diagnostic tool 230 in communication with the remote server 214, may transmit a customized application to debug, develop, and/or monitor variables from one or more modules on the vehicle computing system.

For example, a customer may experience a lack of performance on one or more vehicle features or functions without the vehicle setting a diagnostic trouble code. Since the vehicle has no instrumentation, a service technician and/or engineer may be limited when inspecting the one or more modules that may be related to the lack of performance the customer is experiencing with the vehicle feature/function/system. A prognostic application may allow the technician and/or engineer to write a diagnostic routine that monitors the signals involved in the feature/function/system and run one or more algorithms designed to capture a specific dataset. The prognostic application may allow the engineer and/or technician to request signals related to one or more modules that are not communicated on the vehicle network. The prognostic application may be transmitted to the vehicle computing system from a remote terminal/device. The vehicle may be returned to the customer while allowing the technician and/or engineer to wirelessly connect to the vehicle and monitor variable(s) from the one or more modules for data inspection at any time based on the diagnostic routine transmitted to the vehicle computing system. The diagnostic routine may alert the technician and/or engineer of when any of the trigger conditions that relate to the customer complaint have been met to root cause the problem. The alert may include, but is not limited to, an email, text, and/or instant message.

In another example, a customer may have a vehicle that has set multiple combination of diagnostic faults that may cause the technician to not properly or clearly root cause the actual component, system, feature, function, and/or subsystem initiating the one or more faults. The technician may contact a service representative to receive one or more custom applications to transmit to the customer's vehicle computing system using wireless technology and/or through the on-board diagnostic (OBD) connector port. The service representative and/or engineer may receive the customer's vehicle identification number to transmit the one or more custom application using a terminal 228 and/or service tools 230 to the vehicle computing system 204 through the remote server in communication with both. The terminal 228 and/or wireless service tools 230 may run original equipment manufacturer authentication software to prevent unauthorized access to the vehicle computing system.

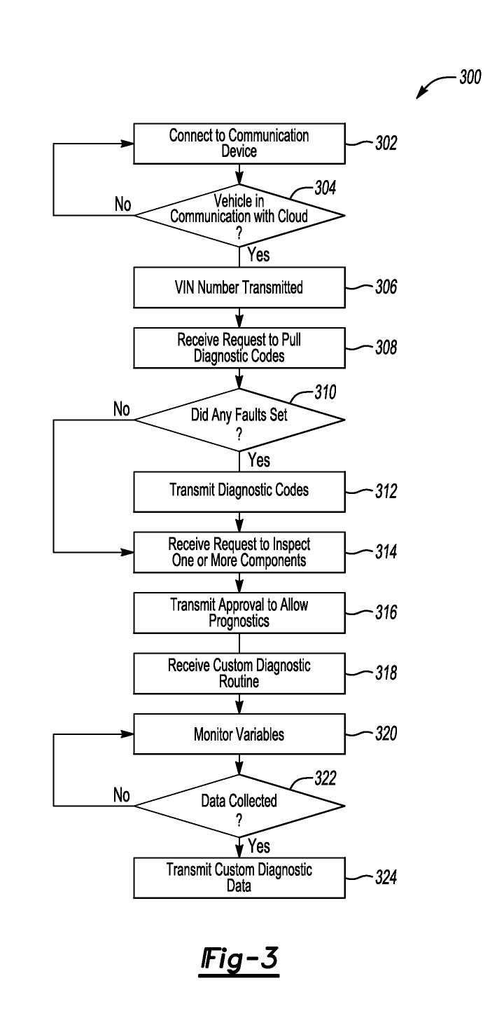

FIG. 3 is a flow diagram illustrating an example processes for implementing embodiments of the present disclosure. The method is implemented using software code contained within the vehicle control module, according to one or more embodiments. In other embodiments, the method 300 is implemented in other vehicle controllers, or distributed amongst multiple vehicle controllers.

Referring again to FIG. 3, the vehicle and its components illustrated in FIG. 1 are referenced throughout the discussion of the method to facilitate understanding of various aspects of the present disclosure. The method of monitoring one or more modules in a vehicle may be implemented through a computer algorithm, machine executable code, or software instructions programmed into a suitable programmable logic device(s) of the vehicle, such as the vehicle control module, the vehicle communication module, other controller in communication with vehicle computing system, or a combination thereof. Although the various steps shown in the flowchart diagram 300 appear to occur in a chronological sequence, at least some of the steps may occur in a different order, and some steps may be performed concurrently or not at all.

The vehicle computing system may be configured to allow a cellular link that connects the customer/engineer through a cloud to the vehicle system. The cellular link connection to the vehicle may allow for remote diagnostic programs that enable a service technician, engineer, and/or customer to have diagnostic access to the entire vehicle computing system. The remote diagnostic functionality to the vehicle computing system enables an engineer using a mobile computing device to have diagnostic access to one or more vehicles. The mobile computing device may include, but is not limited to, the use of a laptop, smart phone, and/or tablet. The one or more vehicles may include, but is not limited to, an entire development fleet.

The vehicle computing system may include a wireless transceiver that enables communication with a wireless device located remotely from the system. The wireless transceiver may include, but is not limited to, an embedded cellular modem, embedded WiFi device, Bluetooth transmitter, Near Field Communication connected to phone, brought-in cellular device like a USB modem, MiFi, smartphone that may be connected to the vehicle through SYNC or other Bluetooth pairing device, or a PC network that may be connected to the vehicle through SYNC or other Bluetooth pairing device. The wireless device located remotely may include, but is not limited to a remote server.

At step 302, the vehicle computing system may connect to a communication device using BLUETOOTH technology or a USB connection. The vehicle computing system may establish communication with the remote sever using the connected communication device at step 304.

At step 306, once the vehicle computing system has established communication with the remote server, the system may transmit the vehicle identification number (VIN). The vehicle computing system may output a set of instructions to a device allowing a service technician and/or engineer access to monitor one or more variables in the system being communicated on the controller area network (e.g. CAN Bus). A service technician and/or engineer may be allowed to request access to communicate to the vehicle using the device. The device may wireless access the VCS using a remote server. The service technician and/or engineer may use one or more service tools including, but not limited to, a computer terminal, a laptop, smart phone, and/or tablet that may be in a remote location away from the vehicle. The one or more service tools may include authentication software to prevent unauthorized access to the vehicle computing system.

The one or more service tools may transmit a request to the vehicle computing system through the remote server to pull diagnostic codes from the vehicle. The vehicle computing system may receive a request to pull diagnostic codes at step 308.

At step 310, the vehicle computing system may determine if any faults are currently active and/or have been stored in history on the one or more modules in the vehicle. The vehicle computing system may transmit to the remote sever the diagnostic codes that are active and/or stored in history at step 312. The service technician and/or engineer may receive the one or more diagnostic code and determine whether to further investigate the modules associated with the codes using data identifier(s) (DID) on the vehicle network, and/or a direct memory read (DMR) of one or more variables on a module not communicated over the vehicle network. Once the vehicle computing system has transmitted the one or more diagnostic codes, it may receive a request to inspect one or more modules and/or components using a DMR request from the one or more service tools communicating through the remote server at step 314.

At step 316, the vehicle computing system may transmit approval to allow the one or more service tools to enable a remote prognostic. The vehicle computing system may receive a diagnostic routine from the remote server allowing the one or more modules to put more information on the vehicle network at step 318. The diagnostic routine may be programmed by a service technician using a service technician tool that includes, but is not limited to, a configurable DID and/or DMR variable list for one or more modules in the vehicle. The VCS may allow the one or more service tools to monitor the diagnostic routine including, but not limited to, one or more variables not available on a vehicle network at step 320.

The one or more variables not available on a vehicle network may include, but is not limited to, CPU utilization, flag status, intermediate voltages, unfiltered sensor reads, diagnostic error counters, timers, diagnostic fault counters, and/or other variables related to the operation of a component, subsystem and/or system. For example, a module may allow twenty one (21) DID variables to be communicated over a vehicle network while having an additional four hundred (400) direct memory read variables in the module software used in making decision for that component, subsystem, and/or system. In another example, the DID may be communicated one at a time over the vehicle network, however the diagnostic routine may be configured to allow for the requested data to be received/recorded in the same time frame and not offset based on the delivery over the vehicle network.

At step 322, the vehicle computing system may collect a dataset based on at least one trigger, timers, and/or flags programmed in the diagnostics instructions. For example, the service technician may program a diagnostics routine to record one or more variables when a vehicle parameter is set. The vehicle parameter may include, but is not limited to, vehicle speed, engine temperature, battery temperature, hybrid mode, and/or engine revolutions per minute. Once the trigger is set, the diagnostic routine begins to collect the dataset and the vehicle computing system may transmit the data to the remote server allowing the service tool to analyze.

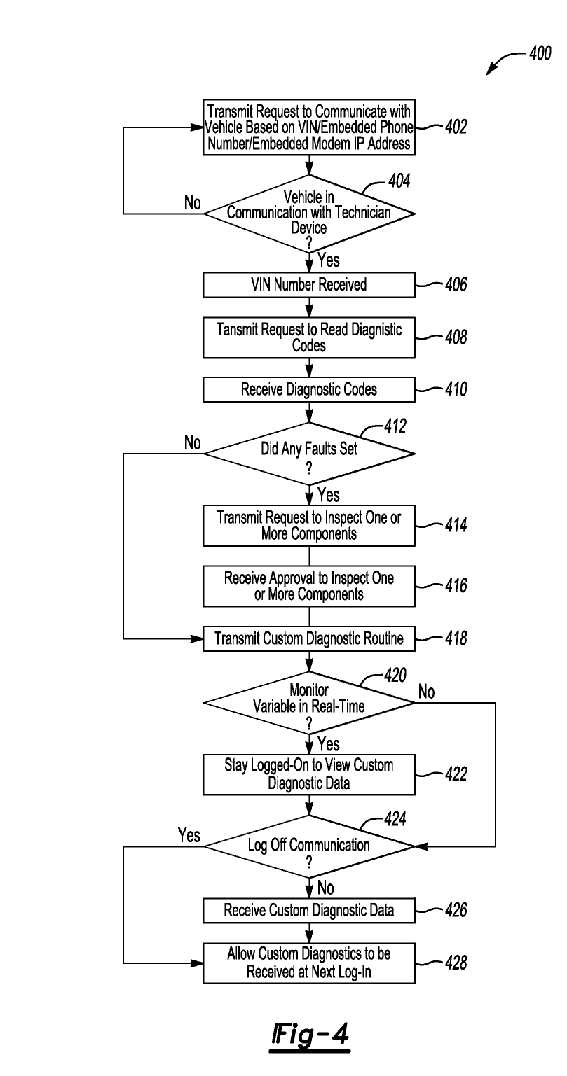

FIG. 4 is a flow chart illustrative of a technician device for communicating with a vehicle computing system. The technician device may include, but is not limited to, a smart phone, laptop, and/or an OEM dealership service/diagnostic tool. The OEM dealership service/diagnostic tool may include, but is not limited to, an OBD scanner. The technician device may communicate with a vehicle using wireless technology and/or a hard wire connection.

At step 402, a technician device may request to communicate with a vehicle based on one or more vehicle identification records including, but not limited to, a vehicle identification number (VIN), an embedded phone number, embedded modem internet protocol (IP) address, and/or a media access control address (MAC). The technician device may communicate to the vehicle using a remote server to bridge the communication from the device to the VCS.

For example, having the VCS use an onboard wireless module integrated with the vehicle allows the system to communicate with a cloud-computing service through wireless technology (e.g. cellular technology). A service technician, engineering, and/or a vehicle owner may use a software application on the technical device (e.g. smartphone application) or website to communicate with the cloud-computing secure server, assisting in up-to-the-minute access to vehicle information and a full suite of remote-controlled functionality including, but not limited to, the request of variables that are not communicated over a vehicle network.

At step 404, the technician device may receive confirmation that it is communication with a vehicle. If the device is in communication with the vehicle it may receive one or more indication variables to identify the tool is connected to the correct vehicle. The device may receive the VIN number stored in the vehicle computing system to ensure that the device is communicating with the correct vehicle at step 406.

The vehicle computing system may display one or more messages to the driver before allowing connection of the technician tool. For example, the device may send a request to connect to a vehicle, and the VCS may communicate this request to the driver by displaying a message indicating the device's request to connect. The driver may allow or reject the request from the device to connect by selecting one or more inputs using the infotainment system user interface. In another example, the driver may initially set up the VCS to allow connection from one or more selected technician devices.

At step 408, the technician device may transmit a request to read diagnostic codes on the one or more modules communicating to the VCS. The technician device may receive the diagnostic codes that are active, are in history, and/or have initiated a counter to set a diagnostic code at step 410. The technician device may determine whether any faults have set and allow the engineer, owner, and/or service technician the option to further analyze a system and/or develop a specific diagnostic routine at step 412.

At step 414, the technician device may transmit a request to inspect one or more systems, subsystems, and/or components based on the active/history diagnostic code received from the vehicle. The VCS may automatically approve the request to inspect one or more modules, and/or the system may display a message asking the driver for approval. For example, if the device received an active diagnostic code related to the throttle body on the engine, the service technician may want additional variables related to the throttle body from the engine control module. Therefore, the device may concentrate on investigating information on the engine control module related to the throttle body including, but not limited to, blade position, reference voltage, accelerator pedal position, and/or throttle sensor information.

At step 416, the device may receive driver approval from the VCS to inspect one or more components. The operator of the device may transmit a specific diagnostic routine based on the customer compliant, diagnostic code(s), and/or system performance at step 418. Continuing from the throttle body example above, the diagnostic routine may include throttle related variables not transmitted over the vehicle network including, but not limited to, diagnostic counter variables (e.g. position sensor out of range counter), error flags, mass airflow variables, and/or mass air pressure variables.

At 420, the operator of the technician device may have the option to monitor the one or more variables included in the requested parameters distributed over the vehicle network and/or in the diagnostic routine. For example an engineer may access the vehicle and monitor current conditions and run tests as required. In some cases an operator at the sight of the vehicle may be used to perform physical tasks such as driving and enabling specific features/functions while the remote engineer gathers data. If the operator chooses to monitor the variables in real-time the device may continue to stay logged-on and communicate with the vehicle at step 422.

At step 424, if the operator of the technician device logs off communication to the vehicle, the customer diagnostic may continue to be executed in the vehicle. If the device remains logged off, the diagnostic routine may include a trigger that has been programmed to record the dataset requested at a certain vehicle event, the device may receive the data after one or more triggers have been enabled at step 426.

At step 428, if the device is logged off, on the next log-in to communicate with the vehicle, the technician may receive the diagnostic data recorded and saved on the VCS. For example, the vehicle may receive the diagnostic routine from the technician device and the customer/driver may proceed to use the vehicle. The diagnostic routine/instructions may continue to be executed without interruption to the customer/driver having to go to a dealership or service garage. Once the diagnostic routine has received the requested dataset based on a parameter including, but not limited to, a trigger, counter, and/or timer, the VCS may notify the device. The VCS may notify the device using several methods including, text message, e-mail message, and/or instant message.

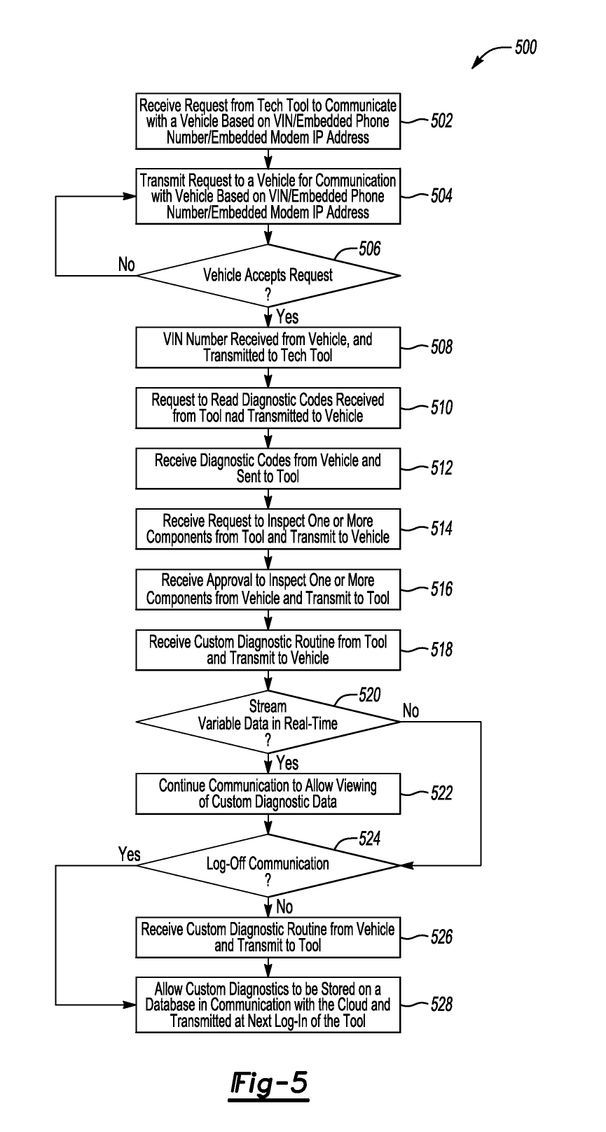

FIG. 5 is a flow chart illustrative of a remote server for communicating an engineering device to a vehicle computing system. The remote server may be an OEM cloud-based secure server helping to ensure security when the remote device has communication access with the VCS. The server may have one or more databases used to store information received from assembly plants regarding vehicle information including, build history, enabled feature/functions, service history, VIN, IP address, embedded phone address, and/or MAC. The server may be in communication with one or more terminals allowed to update information regarding vehicle build data and/or application updates for the engineering device(s).

At step 502, the server may receive a request from a wireless development/diagnostic device wanting to communicate with one or more vehicles using an identification code including, but not limited to, VIN, embedded phone identification address, embedded modem IP address, MAC, and/or a fleet identification number. The server may transmit the request to the identified vehicle(s) for initializing communication with the VCS based on the identification code from the wireless development/diagnostic device at step 504.

At step 506, the vehicle may receive the request allowing the VCS to present one or more messages to an output device including, but not limited to, an instrument cluster, a center-stack LCD display, and/or a smart phone using BLUETOOTH technology in communication with the VCS. For example, the VCS may receive a remote development and/or diagnostic device request for communication and based on that request transmit a message to a driver in the vehicle if h/she would allow the device to communicate by either accepting or denying the communication linking. In another example, the VCS may automatically accept a remote development and/or diagnostic device request for communication based on several factions including, but not limited to, location of the vehicle, OEM settings allowing a wireless service tool to connect while at a service garage, and/or a vehicle owners predefined settings.

At step 508, the server may receive a confirmation response from the VCS including, but not limited to, the VIN, an acceptance message, and/or an encrypted message allowing communication form the VCS to the wireless device through the server. The server may receive a request from the diagnostic/development device to read one or more diagnostic codes from the VCS at step 510. The server may transmit the reading of one or more diagnostic codes to the VCS. The server may receive the one or more diagnostic codes from the vehicle and transmit that information to the device at step 512.

At step 514, based on the one or more diagnostic codes, the user of the diagnostic/development device may request to inspect one or more components for further analysis on the vehicle. The server may transmit an additional approval request to inspect one or more components in communication with the VCS. The one or more components may be on several modules in communication with the VCS. If the server receives an acceptance from the vehicle to inspect the one or more components in communication with the VCS, the server may notify the acceptance to the diagnostic/development device. The server may receive a diagnostic routine from the diagnostic/development device tailored to the performance complaints (e.g. diagnostic codes set) being experienced by the vehicle in communication with the server at step 518.

At step 520, the server may allow the device to view the data being requested from the VCS while it is actually being recorded. For example, a service technician may be with the vehicle while an engineer is in a remote location using the diagnostic/development wireless device to root cause one or more customer complaints on a vehicle. The engineer may transmit a diagnostic instructions based on the compliant, and have the service technician operate the vehicle while s/he views the data instantaneously on the device.

At step 522, the server may allow continuous communication of the device once one or more diagnostics routines have been transmitted to the VCS. The one or more diagnostic routines may including, but is not limited to, one or more algorithms that have triggers, timers, and/or other predefined variables that ensure requested variables are recorded/monitored during a certain vehicle system scenario. The server may allow the vehicle and/or the diagnostic/development device to log off while the diagnostic routine is executed on the VCS allowing the dataset to be recorded and stored in one or more vehicle modules at step 524.

At step 526, the server may receive one or more datasets from the vehicle once it has been recorded and/or the diagnostic routine has completed its analysis based on a trigger, timer, and/or other predefined variables. If the device is logged off from the server, the dataset may be stored on the server and transmitted to the diagnostic/development device at the next log-in at step 528.

For example, the VCS may receive a diagnostic routine from a wireless device through a server to be executed on one or more modules in the vehicle. The vehicle and the wireless device may log-off communication with the server and allow the custom diagnostic to run. The diagnostic instruction may run on the one or more modules in the vehicle and store the recorded data in the electronic control unit register. Once the vehicle establishes communication with the server the data may be transmitted and stored on the server. Once the wireless device establishes communication with the vehicle and/or server, the data may be transmitted to the device.

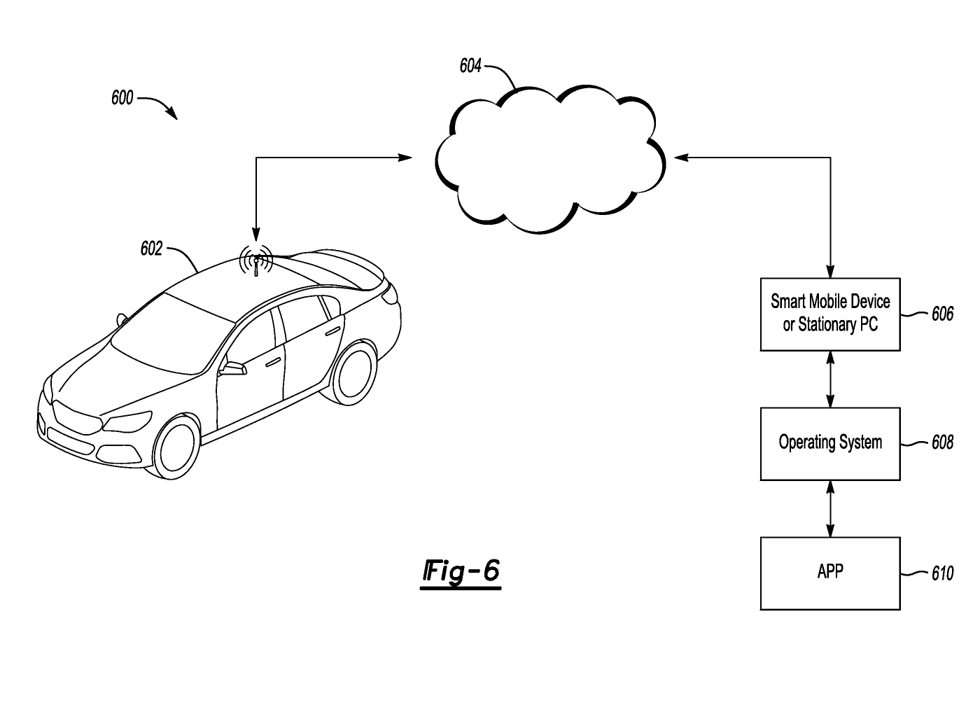

FIG. 6 is an example block topology for a computer device having one or more customized applications used for prognostics of a vehicle system. This is an example of a remote prognostics architecture 600 that may be used to allow one or more mobile devices and/or stationary PC 606 to communicate a programmable diagnostic routine to a vehicle 602. The programmable diagnostic routine may be developed by using one or more applications 610. The one or more applications 610 may be developed to perform monitoring and single-fault root cause analysis for one or more components in a vehicle.

The developed one or more applications may be complied and/or developed for a specific operating system 608. The operating system 608 may be specific based on the mobile device or stationary PC 606 (e.g. Apple devices may have iOS operating system and Samsung devices may have Android operating system). The mobile device and/or stationary PC 606 may be in communication with a server allowing for remote communication with a vehicle 602.

The server 604 may allow streaming of immediate data from the vehicle 602 upon request and/or store the data otherwise in the cloud 604. The vehicle 602 may include, but is not limited to, development vehicles, prototype vehicles, customer vehicles, and/or fleet vehicles. The vehicle may have enhanced data availability based on direct memory read (DMR) of variable(s) in one or more modules in the vehicle 602. The DMR of variables may include, but is not limited to, variables not communicated on the vehicle network (e.g. controller area network bus).

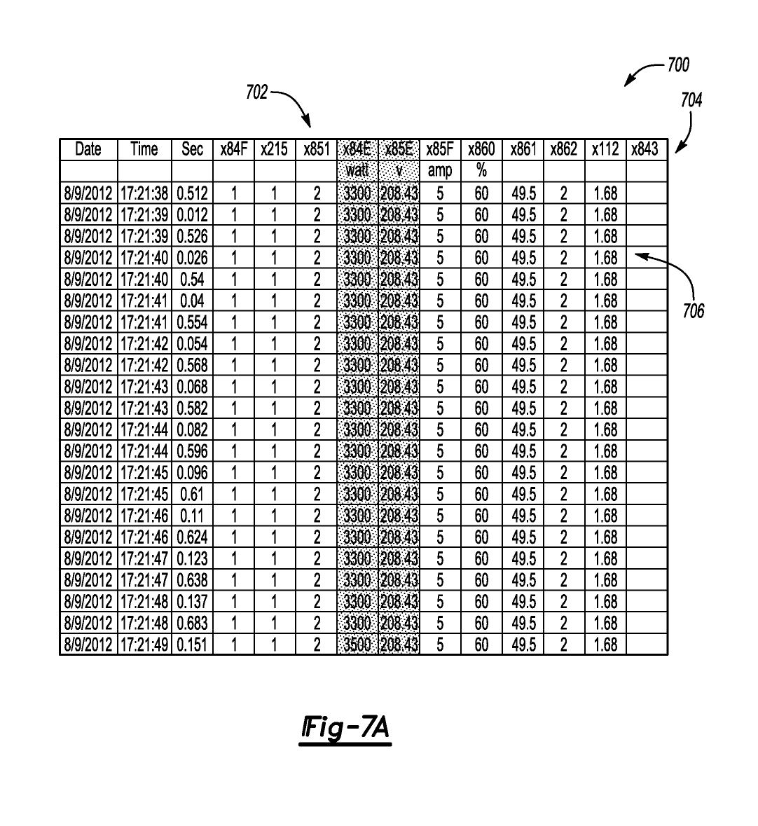

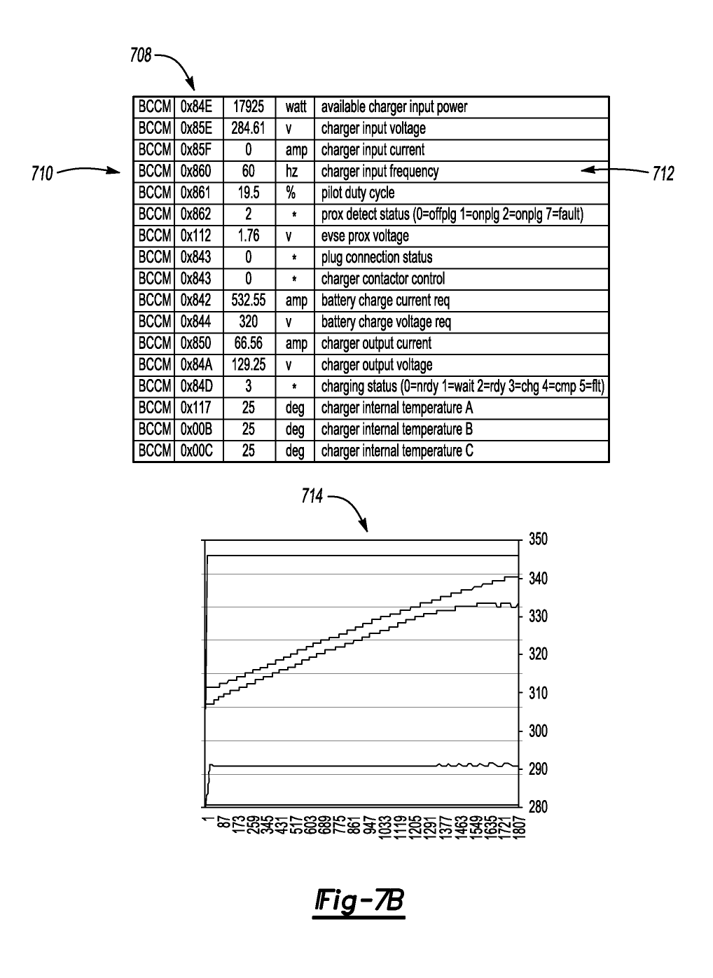

FIG. 7A is an example GUI for receiving data from one or more programmable diagnostic routines executed in a vehicle. The system may deliver a custom dataset 700 as defined by the user of the diagnostic/development device. The data may be presented in a raw form 702 with one or more variables 704 and the associated data 706 listed below the variable. The user may develop an application to display the data in the way that best fits his purpose.

For example, in FIG. 7B the user may develop a display to output the data in a tabular layout 708 with one or more variables 710 listed down the page with the associated data 712 next to it. The data may present the variable information by calling out the respective control module identification (e.g. BCCM, Battery Charging Control Module) and variable address (e.g. in a hex format) combination. The associated data may include, but is not limited to the scientific unit of measurement for that variable and a description of the variable.

Sometimes just raw variable data is sufficient, however if not the user can use common software tools to graph the data, or to place the data in a chart, or some other graphical interface 714 using the diagnostic device. The graphical layout 714 may include one or more variables to allow a user to visually determine how the variables are reacting during vehicle operation. The graphical layout 714 may be defined by a user when developing a custom diagnostic using the diagnostic device.

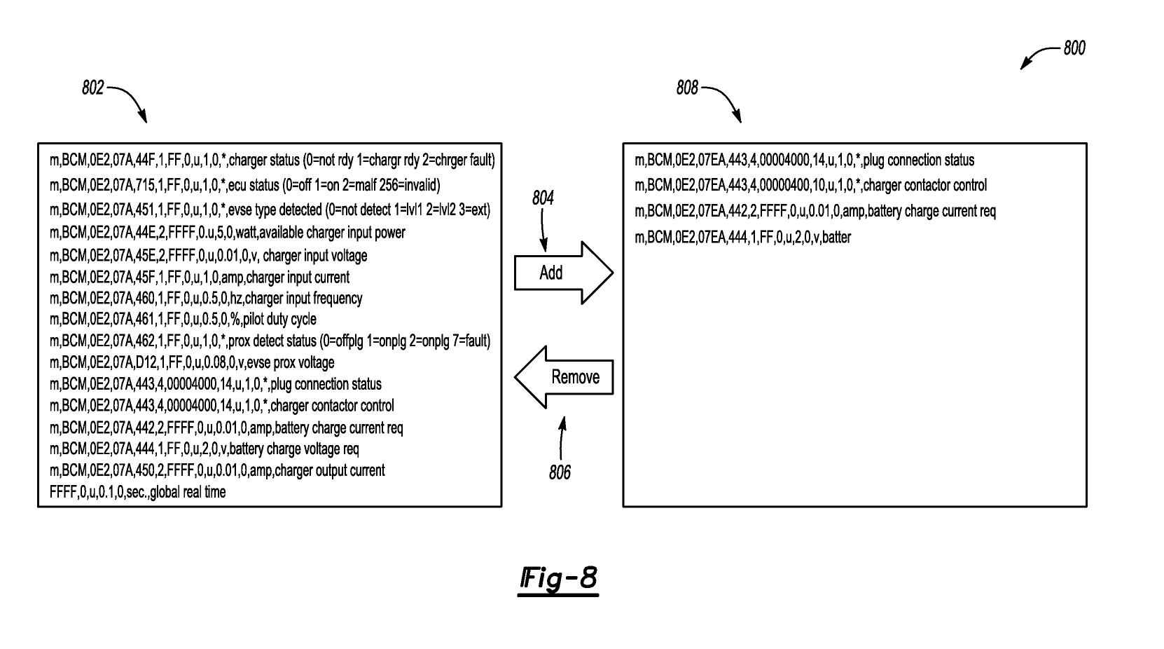

FIG. 8 is an example GUI of selecting one or more data identifiers using a device to be used in a diagnostic instruction and transmitted to a vehicle computing system. The device may include, but is not limited to, a portable cellular phone, laptop, and/or a computer terminal. In another example, the device may include, but is not limited to, a dealership service tool (e.g. Ford STAR Tester, GM TECH 2, etc.).

The device may allow a user to select one or more DIDs to develop a set of variables to be transmitted to the vehicle computing system. The GUI may allow a user to select one or more modules and to view a list of variables 802 related to the selected module. For example, the list of variables 802 for a Battery Charger Module may include, but is not limited to, the controller address, the DID address, the DID scientific measurement, and/or a shot description of the DID. The user may select whether to add 804 or remove one or more variables from the selected DID monitor list 808. Once the user has determined the module(s) and associated variable(s) needed to root cause a customer compliant, or for analysis of a development prototype vehicle, the selected DID monitor list 808 may be transmitted to the VCS using the device.

Once the variables have been transmitted to the VCS, the device may monitor the variables as it is read by the VCS in the vehicle. In another example, the one or more DIDs may be transferred to the VCS and the recorded DID data may be stored by one or more modules in the VCS until the device logs-in and/or requests to collect the recorded data.

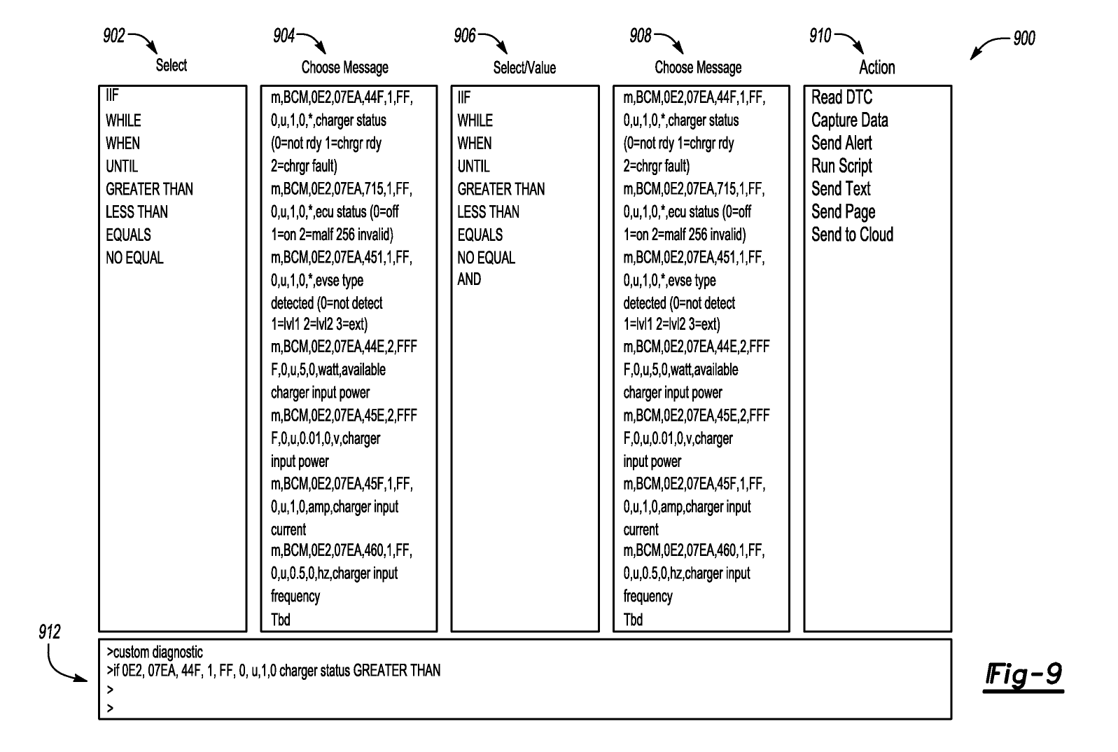

FIG. 9 is an example GUI of selecting diagnostic capture triggers to be used in a diagnostic instruction and transmitted to a vehicle computing system. A server may be in communication with one or more prototype vehicles during product development. The one or more prototype vehicles may go on test trips to validate one or more components, subsystems, and systems. During the test trip, one or more faults may be set based on the combination of a driving maneuver, road grade, and/or the environmental condition. A custom diagnostic may be developed to capture the data using several variable triggers including, but not limited to, battery state of charge value, battery charging status, vehicle speed, and/or transmission oil temperature.

A software application may be used on a development device in communication with the one or more prototype vehicles to develop and transmit the programmable diagnostic routine(s). The software application on the development device may have a GUI that provides a user with a list of options 900 to develop a diagnostic instruction including, but not limited to, selecting a conditional variable 902, choosing a module variable 904, selecting a conditional measurement variable 906, and/or choosing one or more additional module variables 908. The software application may allow the diagnostic instructions to include an action 910 to transmit to the development device when the one or more triggers have been set and/or the variable data has been recorded.

The software application GUI may allow the user to select and choose one or more conditions and variables and populate the diagnostic instruction algorithm 912. After the diagnostic instruction/routine is complete, the development device may compile and transmit the diagnostic instruction/routine to the one or more prototype vehicles through a server. The one or more prototype vehicles may receive the custom diagnostic and store it in the VCS. Once the one or more triggers, conditions, and/or timers have been met, the custom diagnostic may collect the request data. Once the data has been collected, the custom diagnostic may transmit a message to the development device including, but not limited to, a text, page, and/or email. The development device may download the data based off the custom diagnostic from the one or more prototype vehicle for further analysis.

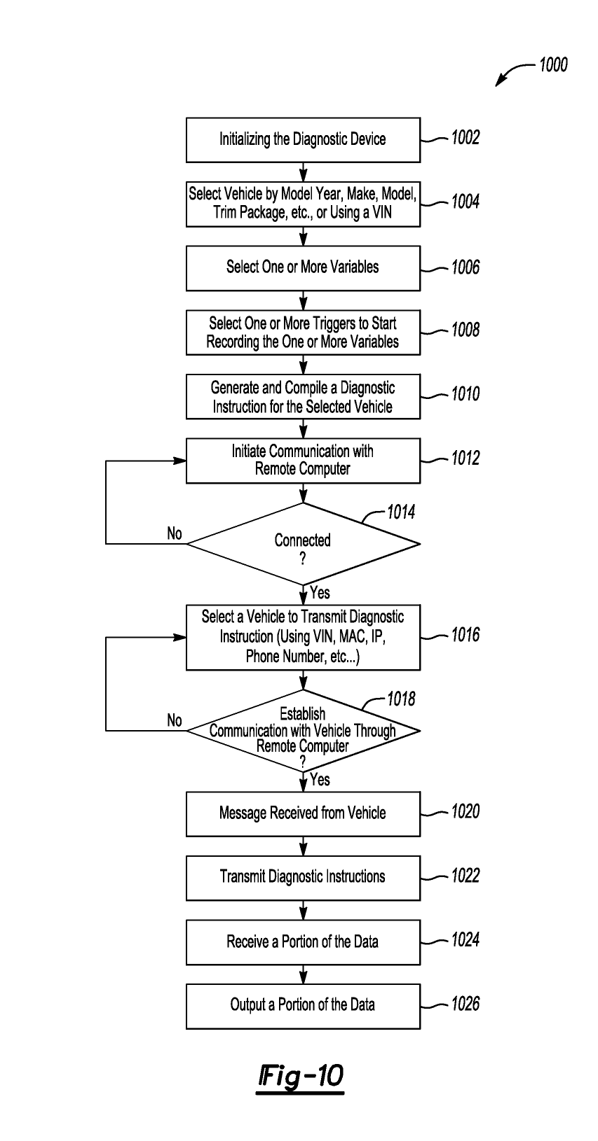

FIG. 10 is a flow chart of a diagnostic device for generating and transmitting an instruction set to capture one or more variables on a vehicle computing system. The diagnostic device may include, but is not limited to, a portable cellular phone, a laptop computer, a computer terminal, and/or an OEM/aftermarket device used to communicate with a vehicle for diagnostic and analysis purposes. The diagnostic device may communicate with a server to retrieve specific vehicle information including, but not limited to, software and calibration variables. The server may have one or more databases to store vehicle information based on vehicle build history and/or service records. The databases may store the vehicle information based on identification of a vehicle using one or more vehicle identifiers including, but not limited to, a VIN, a MAC address, embedded phone address, and/or the IP address associated with the WiFi/MiFi embedded system.

At step 1002, the diagnostic device may be initialized to perform analysis on a VCS based on one or more processors configured by a software application running on the device. The software application may include, but is not limited to, on-board diagnostic and reporting capability. The software application further includes one or more options to develop and compile diagnostic routines by selecting diagnostic information available via OBD and addition information on one or more modules not communicated over a vehicle network.

At step 1004, a user may select a specific vehicle to develop and transmit a diagnostic instruction/routine based on one or more identifies including, but not limited to, the vehicle model year, vehicle make, vehicle model, trim package, powertrain system, and/or VIN. For example, if a user wants to develop a diagnostic routine for a 2005 Ford Focus with a four cylinder powertrain engine and a four speed transmission, the user may enter the information into the device and be allowed to select one or more variables based on the modules available in that selection. The user may also enter a VIN to pull up the variables to develop a diagnostic instruction based on that specific vehicle build.

At step 1006, once a vehicle is selected, the diagnostic device may allow a user to select the variables that are available based a number of factors including, but not limited to, the options available on that vehicle, the features/functions, systems, subsystems, build information for a particular vehicle, and/or service history of the vehicle. The device may allow a user to select one or more triggers to include in the diagnostic instructions that may enable the start to record the necessary data and another trigger to stop the recording at step 1008.

For example, a technician may be working on a vehicle and would like to create a diagnostic test to capture data related to a feature on that vehicle. The technician may enter the VIN into the device to retrieve the variables and the associated module/variable addresses that are available for that vehicle.

In another example, an engineer may develop a diagnostic instruction for a fleet of vehicles built in the same module year and/or are the same make and model. The engineer may make this diagnostic instruction based on a specific complaint that is seen in the field so that a technician may pull the instruction and use it to properly root cause a problem/compliant.

At step 1010, after the user has developed a diagnostic instruction, the device may compile the instruction for the selected vehicle(s). The device may initiate communication with a remote computer to bridge communication between the diagnostic device and one or more vehicles at step 1012. The remote computer may include an OEM server that enables the device to communicate with OEM vehicles. For example, once a vehicle is assembled by an OEM the build history of the vehicle may be transmitted with the VIN to be stored at the remote computer. The remote computer may be allowed to communicate with the vehicle using an embedded cellular module in the vehicle and/or a registered portable cellular phone associated with the owner of the vehicle. The registered portable cellular phone may transfer communication from the remote computer to the vehicle using BLUETOOTH technology.

At step 1014, the device may notify a user when a connection is made to the remote computer or to make several attempts if the connection has failed. Once connected to the remote computer, the diagnostic device may select one or more vehicles to transmit the diagnostic instruction to using several methods including, but not limited to, a VIN, MAC, IP, and/or a registered portable cellular phone number at step 1016. Based on the several methods for the device to identify the one or more vehicles to communicate the diagnostic instruction to, the remote computer may make several attempts to communicate with the vehicle(s) at step 1018.

At step 1020, if the remote computer has established communication with the vehicle, the remote computer may receive feedback from the vehicle accepting the communication with the diagnostic device. The device may transmit the diagnostic instruction to the vehicle through the remote computer communicating with the vehicle. In another example, the device may make a hard wire connection to the vehicle using the OBD port and transmit the diagnostic instructions directly to the vehicle system without the use of wireless communication between the diagnostic device and the vehicle computing system.

At step 1024, the diagnostic device may receive a portion of the data once the diagnostic instruction has been enabled and executed on the vehicle computing system. The portion of data may include, but is not limited to data from memory of one or more modules. The diagnostic device may output a portion of the data on one or more displays including, but not limited to an LCD screen at step 1026.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention

What is claimed is:

1. A diagnostic device comprising:
a computer processor in communication with a wireless transceiver, the wireless transceiver capable of communication with a remote computer located remotely from the processor, the computer processor configured to:
select one or more variables from the remote computer in communication with a database;
generate a diagnostic instruction for a vehicle based on the one or more variables, the diagnostic instruction including a request for data from memory of one or more modules that is not available on a vehicle network;
transmit the diagnostic instruction to the vehicle in communication with the remote computer; and
receive from the vehicle at least a portion of the data in response to the diagnostic instruction.

2. The diagnostic device of claim 1, wherein the one or more variables are based on module identification and a variable addresses.

3. The diagnostic device of claim 1, wherein the diagnostic instruction includes one or more triggers of a vehicle event defining when to start collecting the data.

4. The diagnostic device of claim 3 wherein the vehicle event is a battery charging status.

5. The diagnostic device of claim 1, further comprising an output of the at least a portion of the data.

6. The diagnostic device of claim 5, wherein the output is a portable cellular phone.

7. The diagnostic device of claim 5, wherein the output is on a computer terminal.

8. A non-transitory computer readable storage medium, storing instructions that, when executed by a processor, configure the processor to:
select one or more variables from a database in communication with the processor;
generate a diagnostic instruction for a vehicle based on the one or more variables, the diagnostic instruction including a request for data from memory of one or more modules that is not available on a vehicle network;
transmit the diagnostic instruction to the vehicle in communication with the processor; and
receive from the vehicle at least a portion of the data in response to the diagnostic instruction.

9. The non-transitory computer readable storage medium of claim 8 storing additional instructions, when executed, causes a processor to output the at least a portion of the data.

10. The non-transitory computer readable storage medium of claim 9 wherein the output is on a laptop.

11. The non-transitory computer readable storage medium of claim 8 wherein the database in communication with the processor using WiFi technology.

12. The non-transitory computer readable storage medium of claim 8 wherein the vehicle in communication with the processor using an on-board diagnostic connecter.

13. The non-transitory computer readable storage medium of claim 8 wherein the vehicle in communication with the processor using cellular technology.

14. The non-transitory computer readable storage medium of claim 8 wherein the diagnostic instructions includes one or more triggers to start collecting the data.

15. The non-transitory computer readable storage medium of claim 14 wherein the one or more triggers is a timer.

16. A method comprising:
selecting a variable from a database, the variable representing a memory location;
generating an instruction for a vehicle based on the variable, wherein the instruction includes a trigger and a request for data from memory of one or more modules that is not available on a vehicle network;
transmitting the instruction to the vehicle; and
receiving from the vehicle at least a portion of the data in response to the instruction.

17. The method of claim 16 further comprising outputting the at least a portion of the data to a device.

18. The method of claim 17 wherein the device is a service technician tool.

19. The method of claim 17 wherein the device is a computer terminal.

20. The method of claim 16 wherein the trigger includes a vehicle event.
